(19) United States
(12) Patent Application Publication
(10) Pub. No.: US 2022/0026198 A1
(43) Pub. Date: Jan. 27, 2022

(54) METHODS AND APPARATUSES FOR ALIGNING A LASER MODULE IN A LiDAR SYSTEM

(71) Applicant: Beijing Voyager Technology Co., Ltd., Beijing (CN)

(72) Inventors: Anan Pan, Fremont, CA (US); Henghui Jiang, Newark, CA (US)

(21) Appl. No.: 16/939,878

(22) Filed: Jul. 27, 2020

(51) Int. Cl. G01B 11/27; G01S 17/931; G01S 7/481; B32B 7/12

(52) U.S. Cl. CPC G01B 11/27; G01S 17/931; B32B 2551/00; B32B 7/12; G01S 7/4814

(57) ABSTRACT

A laser module and an optical lens assembly in a LiDAR system for a vehicle can be optically aligned by movably coupling alignment blocks to a chassis with screws. The alignment blocks may be fixedly coupled to the chassis with cured adhesive. Non-solid gap filler may be positioned between the laser module and the chassis, and the laser module may be oriented relative to the optical lens assembly to an optically aligned orientation so that a path of a laser beam emitted from the laser module is oriented with an optical path in the optical lens assembly. Adhesive may be applied and cured between the alignment blocks and the laser module with the laser module in the optically aligned orientation in order to fixedly couple the laser module to the alignment blocks and the chassis in the optically aligned orientation.

### BACKGROUND

Modem vehicles are often equipped with sensors designed to detect objects and landscape features around the vehicle in real-time to enable technologies such as lane change assistance, collision avoidance, and autonomous driving. A commonly used sensor is a light detection and ranging (LiDAR) system.

A LiDAR system may include a light source, also referred to as a transmission module, and a light detection system, also referred to as a receiver module, to estimate distances to environmental features (e.g., pedestrians, vehicles, structures, plants, etc.). The transmission module may include a laser module and an optical lens assembly. The laser module may include a circuit board mounted laser configured to emit a laser beam that is optically aligned with the optical lens assembly. The emitted laser beam is used to illuminate a target and the LiDAR system measures the time it takes for the transmitted laser beam to arrive at the target and then return to the receiver module. In some LiDAR systems, the laser beam may be steered across a region of interest according to a scanning pattern to generate a “point cloud” that includes a collection of data points corresponding to target points in the region of interest. The data points in the point cloud may be dynamically and continuously updated, and may be used to estimate, for example, a distance, dimension, and location of an object relative to the LiDAR system, often with very high fidelity (e.g., within about 5 cm) due to the precision of the optical alignment of the components.

### BRIEF SUMMARY

In embodiments, a method of optically aligning a laser module with an optical lens assembly coupled to a chassis in a LiDAR system may include movably coupling a first alignment block to the chassis with a first screw fixedly coupled to the chassis. The method may further include, applying a first portion of adhesive on the first alignment block and the first screw, applying a second portion of adhesive on the first alignment block and the laser module. The method may further include, applying a non-solid gap filler between the laser module and the chassis, orienting the laser module relative to the optical lens assembly, with the non-solid gap filler between the chassis and the laser module, to an optically aligned orientation wherein a path of a laser beam emitted from the laser module is oriented with an optical path in the optical lens assembly. The method may further include, curing the non-solid gap filler between the chassis and the laser module, curing the first portion of adhesive in order to fixedly couple the first alignment block to the first screw and the chassis, and curing the second portion of adhesive, after curing the first portion of adhesive, with the laser module in the optically aligned orientation, in order to fixedly couple the laser module to the first alignment block and the chassis in the optically aligned orientation.

In embodiments, the first alignment block may be movably coupled to the chassis so that the first alignment block is translatable relative to the chassis. The method may further include translating relative to the chassis after coupling the first alignment block to the chassis and prior to curing the first portion of adhesive. In embodiments, the first alignment block may include a rectangular prism body defining a first elongated slot and a second elongated slot. In embodiments, movably coupling the first alignment block to the chassis with the first screw may include positioning the first screw within the first elongated slot. In embodiments, the method may include securing the first alignment block to the chassis with a second screw positioned within the second elongated slot. In embodiments, the first and second elongated slots and the first and second screws may be configured to allow the first alignment block to translate in a single degree of freedom relative to the chassis. In embodiments, the method may include translating the first alignment block relative to the first and second screws after coupling the first alignment block to the chassis and prior to curing the first portion of adhesive.

In embodiments, the first and second screws may be shoulder screws each comprising a threaded end, an unthreaded central portion, and a head. The first and second elongated slots may each define a depth, a length and a width less than the length. The unthreaded central portions of each of the first and the second screws may define a first diameter corresponding to the width of the first and second elongated slots. The heads of each of the first and second screws may define a second diameter greater than the first diameter and greater than the widths of the first and second elongated slots.

In embodiments, the heads of each of the first and second screws may include a textured side wall surface, and applying the first portion of adhesive on the first alignment block and the first screw may include applying the first portion on the textured side wall surface of the first screw. In embodiments, the first alignment block may define a recess between the first elongated slot and the second elongated slot, and applying the first portion of adhesive on the first alignment block and the first screw may include applying the first portion in the recess. In embodiments, the first alignment block may define a top surface and a recessed surface offset from the top surface, the heads of the first and second screws may project away from the top surface of the secured first alignment block, applying the second portion of adhesive on the first alignment block and the laser module may include applying the second portion of adhesive onto the recessed surface.

In embodiments, the laser module may include, a second chassis, a circuit board fixedly coupled to the second chassis, and a laser fixedly coupled to the circuit board. Applying the non-solid gap filler between the laser module and the chassis may include applying the non-solid gap filler between the second chassis and the chassis.

In embodiments, the non-solid gap filler may not be applied between the first alignment block and the chassis. In embodiments, the first portion of adhesive and the second portion of adhesive may not contact the non-solid gap filler. In embodiments, curing the non-solid gap filler may be performed simultaneously with or after orienting the laser module to the optically aligned orientation. In embodiments, curing the first portion of adhesive may be performed prior to orienting the laser module to the optically aligned orientation.

In embodiments, the method may include securing a second alignment block to the chassis with a third screw fixedly coupled to the chassis, applying a third portion of adhesive on the second alignment block and the third screw, applying a fourth portion of adhesive on the second alignment block and the laser module, wherein the first alignment block may be positioned on a first side of the laser module and the second alignment block is positioned on a second side of the laser module perpendicular to the first side of the laser module, curing the third portion of adhesive in order to fixedly couple the second alignment block to the third screw and the chassis, and curing the fourth portion of adhesive, after curing the third portion of adhesive, with the laser module in the optically aligned orientation, in order to fixedly couple the laser module to the second alignment block and the chassis in the optically aligned orientation.

In embodiments, a transmission module in a LiDAR system may include, a chassis, an optical lens assembly coupled to a chassis, a first alignment block, a first screw fixedly coupled to the chassis and extending through a first elongated slot of the first alignment block, and a laser module. The first screw may be fixedly coupled to the first alignment block with a first portion of adhesive. A second portion of adhesive may be positioned between the laser module and the first alignment block so that the laser module is fixedly coupled to the first alignment block. The first and second portions of adhesive may maintain the laser module in an optically aligned orientation with the optical lens assembly wherein a path of a laser beam emitted from the laser module is oriented with an optical path in the optical lens assembly.

In embodiments, the first screw and the first elongated slot may be configured to allow the first alignment block to translate relative to the chassis prior to an application of the first portion of adhesive. In embodiments, the transmission module may include a second screw fixedly coupled to the chassis and extending through a second elongated slot of the first alignment block. The second screw may be fixedly coupled to the first alignment block with a third portion of adhesive. The first alignment block may include a rectangular prism body defining the first elongated slot and the second elongated slot.

In embodiments, the first and second screws may be shoulder screws each comprising a threaded end, an unthreaded central portion, and a head. The first and second elongated slots each may define a depth, a length and a width less than the length. The unthreaded central portions of each of the first and the second screws may define a first diameter corresponding to the width of the first and second elongated slots. The heads of each of the first and second screws may define a second diameter greater than the first diameter and greater than the widths of the first and second elongated slots.

In embodiments, the heads of each of the first and second screws may include a textured side wall surface, and the first portion of adhesive may be bonded to the first alignment block and the textured side wall surface of the first screw. The first alignment block may include a top surface defining a recess, and the first portion of adhesive may be bonded to the first alignment block within the recess and bonded to the first screw. The first alignment block may define a top surface and a recessed surface offset from the top surface, and the second portion of adhesive may be bonded to the recessed surface and a second chassis of the laser module.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. IA shows a portion of a transmission module of an autonomous vehicle LiDAR assembly including a chassis, a laser module, and alignment blocks, according to certain embodiments;

FIGS. 2A-2C show views of a laser module, according to certain embodiments;

FIGS. 3A and 3B show views of a chassis of a laser module, according to certain embodiments;

FIGS. 4A-4D show views a shoulder screw, according to certain embodiments;

FIGS. 5A-5C show views an alignment block, according to certain embodiments:

FIGS. 6A and 6B show translation of an alignment block movably coupled to a chassis, according to certain embodiments; and

FIGS. 7A-7H show steps of optically aligning and fixedly coupling a laser module to a chassis using alignment blocks, according to certain embodiments.

Throughout the drawings, it should be noted that like reference numbers are typically used to depict the same or similar elements, features, and structures.

### DETAILED DESCRIPTION

Aspects of the present disclosure relate generally to aligning a laser module relative to an optical lens assembly, and securing the laser module in an optically aligned orientation using one or more alignment blocks fixedly coupled to the laser module and fixedly coupled to a chassis to which the optical lens assembly is fixedly coupled. The chassis, laser module, and optical lens assembly may be part of a LiDAR assembly, according to certain embodiments.

In the following description, various examples of laser module optical alignment and securing techniques are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

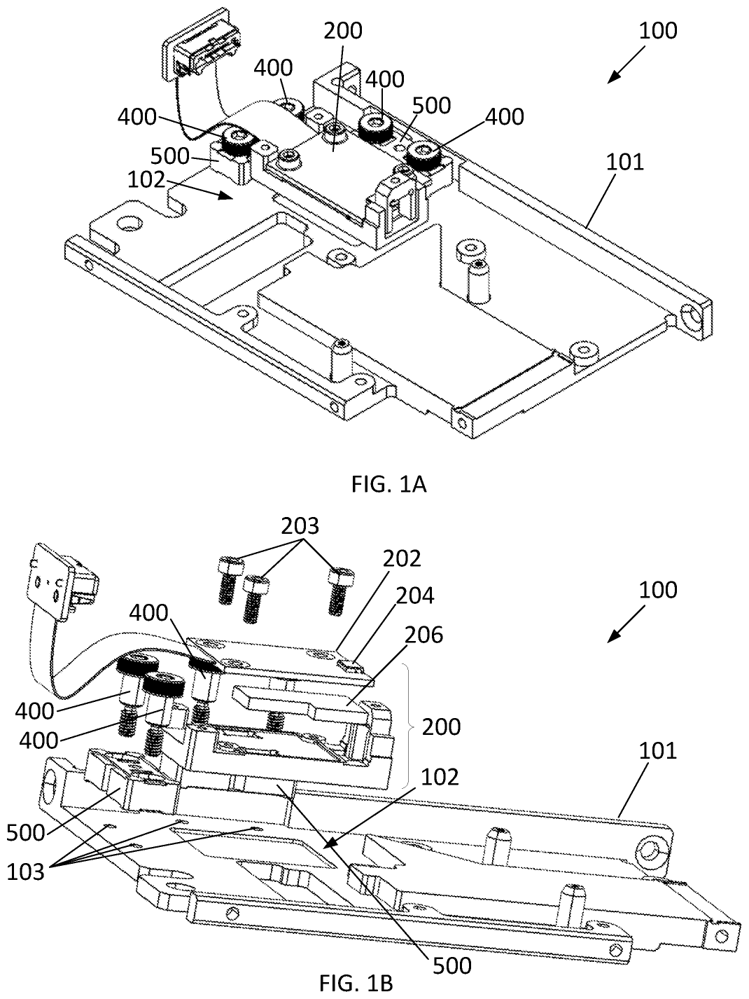

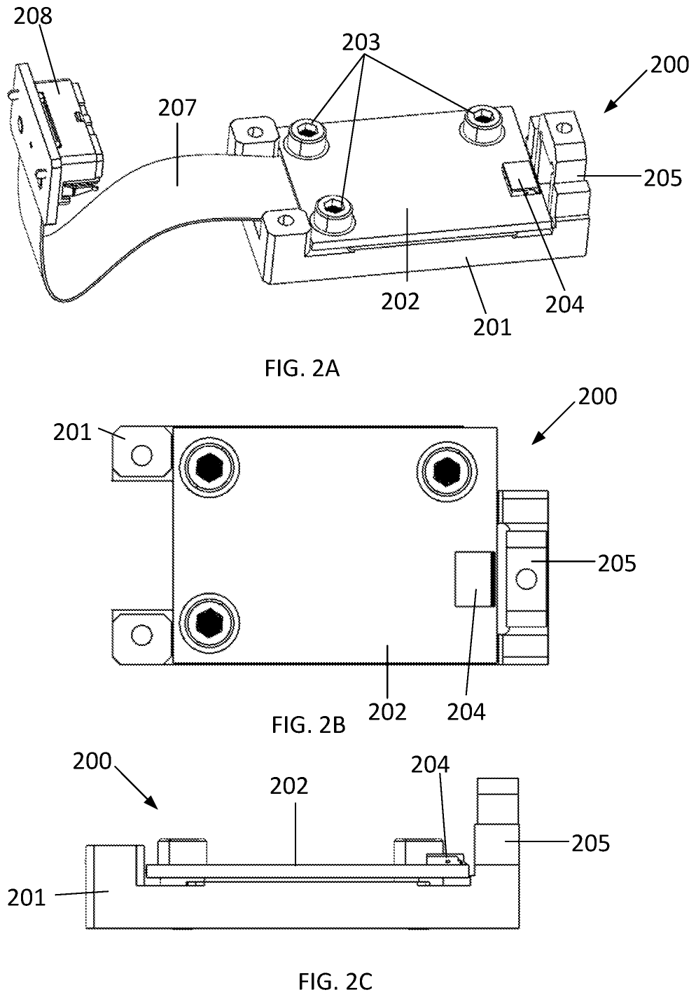

The following high-level summary is intended to provide a basic understanding of some of the novel innovations depicted in the figures and presented in the corresponding descriptions provided below. Generally, aspects of the invention are directed to implementations of fixedly coupling a laser module to a chassis in an optically aligned orientation with an optical lens assembly coupled to the chassis. For example, a Light Detection and Ranging (LiDAR) assembly of an autonomous vehicle may include a transmission module (TX), or combination transmission and receiving module (TX/RX), including a laser module. The laser module comprises a laser module chassis, a circuit board coupled to the laser module chassis, and a laser coupled to the circuit board, for example a shown in FIG. 2A. A laser beam emitted from the laser is directed into an optical path of the optical lens assembly. Due to manufacturing tolerances, the directions laser beams are emitted from different laser modules may be inconsistent from one another. Examples of manufacturing tolerances include manufacturing tolerances of: the laser, the circuit board, the laser module chassis, assembly of the laser to the circuit board, and assembly of the laser module. LiDAR requires precise optical alignment of components in order to ensure accurate measurements, and therefore each unique laser module is optically aligned during the assembly of the transmission module.

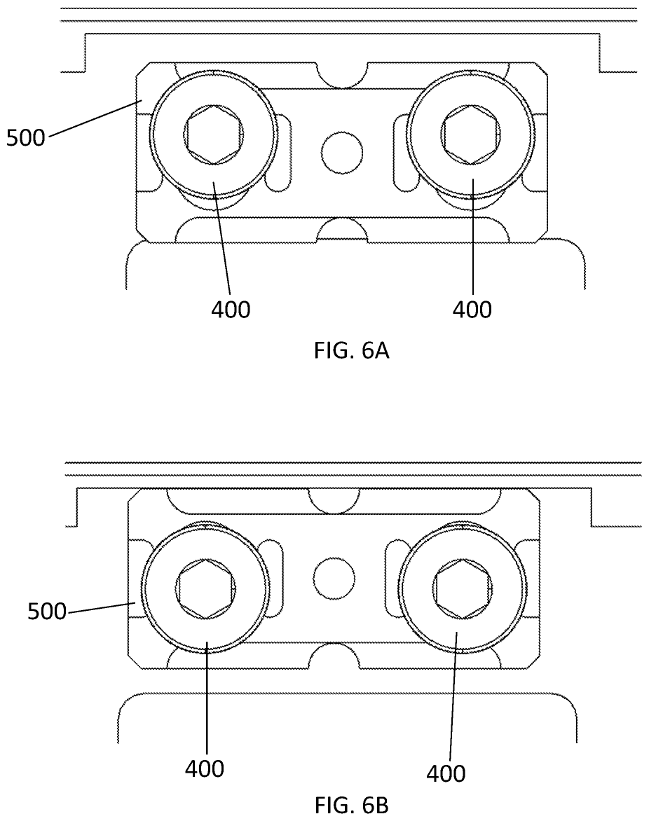

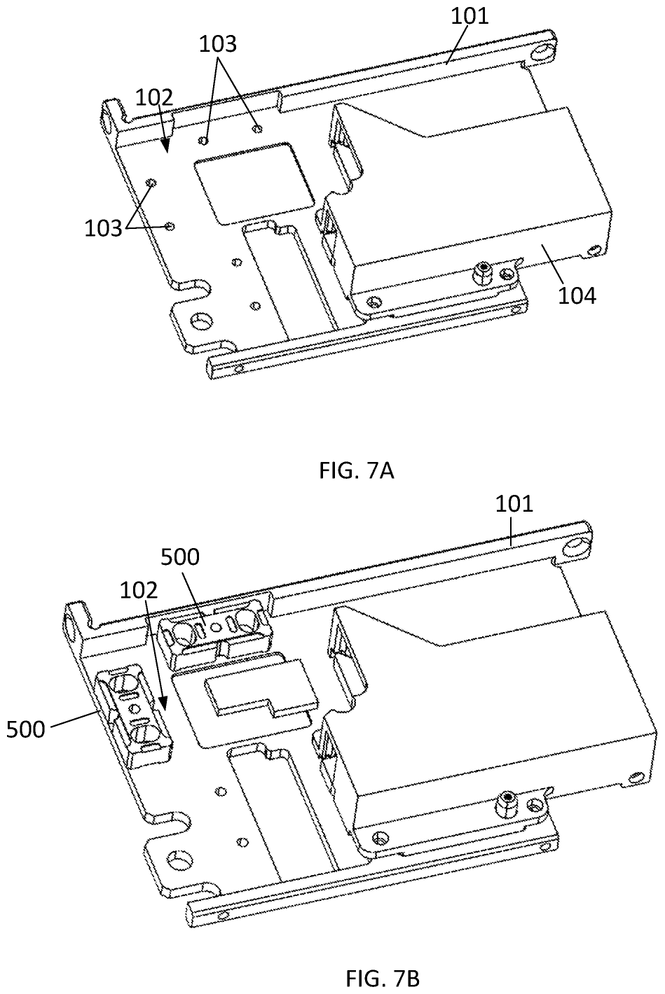

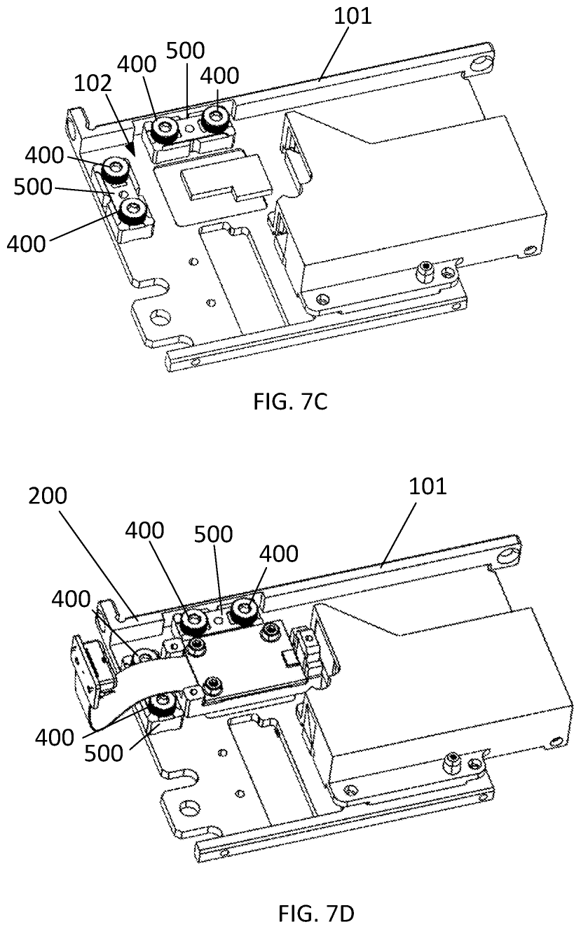

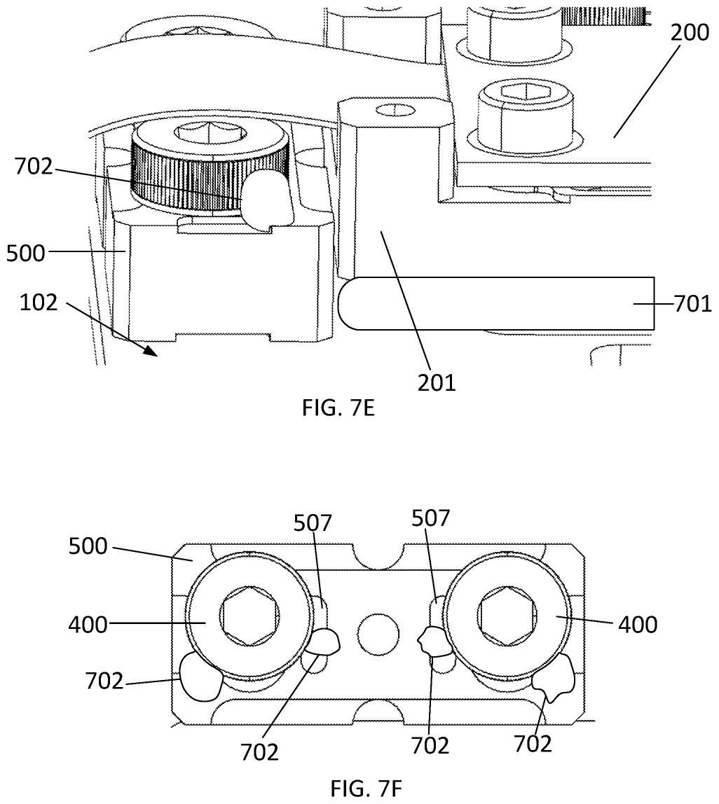

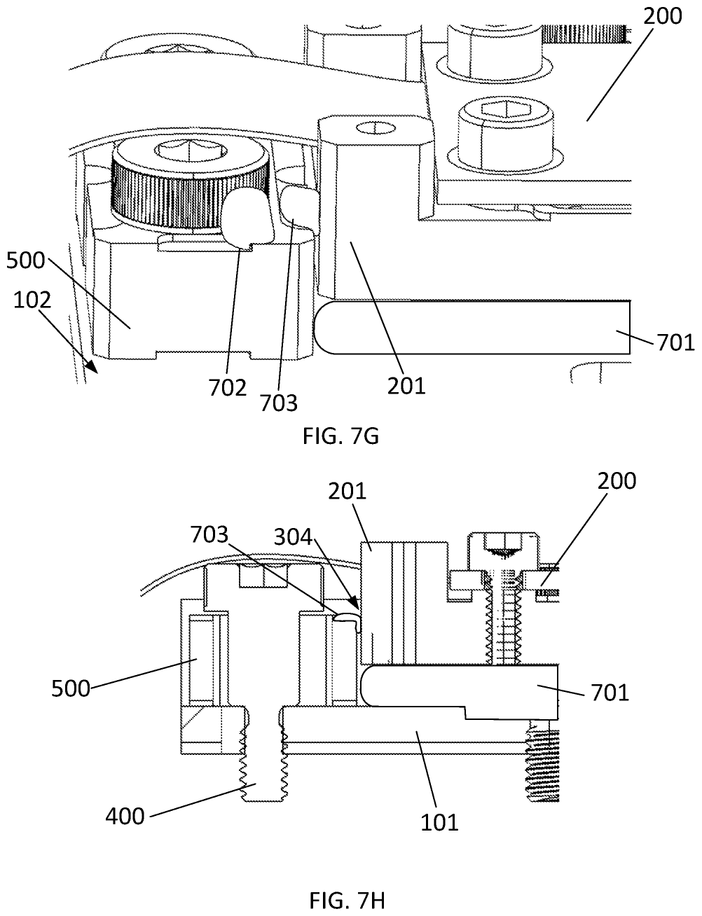

The present technology relates to the use of alignment blocks and adhesives to fixedly couple the laser module to the chassis of the transmission module in an optically aligned orientation. Specifically, one or more alignment blocks may be movably coupled to the chassis of the transmission module in order to have one or mode degrees of freedom prior to application of adhesive, for example as shown in FIGS. 6A and 6B. The alignment blocks are coupled to the chassis around the laser module, and positioned so that the laser module is fixed in the optically aligned orientation by being bonded to the alignment block with adhesive, as shown for example in FIGS. 7G and 7H. After positioning the alignment blocks with the one or more degrees of freedom, the alignment blocks may be fixedly coupled relative to the chassis with adhesive, as shown for example in FIGS. 7E and 7F. The adhesive fixedly coupling the alignment blocks may be applied between the alignment blocks and one or more screws fixedly coupled to the chassis. The use of adhesives allows for precise positioning of the alignment blocks relative to the chassis, and the laser module relative to the alignment blocks and therefore the chassis. The figures are further described in greater detail below and the scope of the various embodiments of the present invention is not limited by this summary, which merely operates to present a high-level understanding of some of the novel concepts that follow.

FIG. 1A shows a portion of a transmission module 100 of an autonomous vehicle LiDAR assembly. As shown, the transmission module 100 comprises a chassis 101, a laser module 200, two alignment blocks 500, and a plurality of shoulder screws 400 movably coupling the alignment blocks 500 to the chassis 101. FIG. 1B, shows an exploded view of the transmission module 100. As shown, the chassis 101 comprises a mounting surface 102. The mounting surface 102 defines threaded holes 103 for threadedly receiving the shoulder screws 400. In embodiments, for example as shown in FIGS. IA and 1B, the transmission module 100 comprises two alignment blocks 500 positioned on perpendicular sides of the laser module 200, however in embodiments a transmission module 100 may include other numbers of alignment blocks 500 positioned on one, two, or more sides of a laser module 200.

The transmission module 100 further comprises an optical lens assembly 104. The laser module 200 is oriented in an optically aligned orientation so that a path of a laser beam emitted from the laser module is oriented with an optical path in the optical lens assembly 104. The precise alignment of the laser module allows for the LiDAR assembly to generate precise measurements.

As will be discussed in greater detail below, the shoulder screws 400 may not directly fixedly couple the alignment blocks 500 to the chassis 101. The shoulder screws 400 may movably couple the alignment blocks to the chassis 101 and therefore allows the alignment blocks to be moved relative to the chassis in at least one degree of freedom, for example translation toward and away from the laser module 200. Not shown in FIG. 1A for clarity purposes, but shown in FIGS. 7E and 7F, adhesives may be positioned between the shoulder screws 400 and the alignment blocks 500 to fixedly couple the alignment block to the shoulder screws, and therefore to the chassis to which the shoulder screws are fixedly coupled.

As shown in FIGS. IA and 1B, the laser module 200 may not be directly coupled to the chassis 101 with mechanical fasteners. As will be discussed in greater detail below, the laser module 200 may be supported above the mounting surface 102 of the chassis 101 with a gap filler, which may be applied as a non-solid gap filler. Not shown in FIG. 1A for clarity purposes, but shown in FIGS. 7G and 7H, adhesives may be positioned between the alignment blocks 500 and the laser module 200 to fixedly couple the laser module 200 to the alignment blocks 500. With the laser module 200 fixedly coupled to the alignment blocks 500 with adhesive, and the alignment blocks 500 fixedly coupled to the chassis 101 adhesive, the laser module 200 is fixedly coupled to the chassis 101.

As shown in FIGS. 2A-2C the laser module 200 comprises a laser module chassis 201. As used herein, the chassis 101 may be referred to as the chassis or the first chassis, and the laser module chassis 201 may be referred to as the second chassis. A circuit board 202 is coupled to the laser module chassis 201 with a plurality of fasteners 203. A laser 204 is coupled to the circuit board 202. Examples of lasers include a 905 nm laser, however other wavelength lasers may be used. The laser module 200 may comprise wiring 207 coupled between an electrical connector 208 and the circuit board 202 for transferring electrical signals to and from the circuit board and other components of the LiDAR system.

The laser module chassis 201 may define a lens bracket 205 housing a lens through which a laser beam emitted from the laser 204 passes prior to entering the optical lens assembly 104. As shown in FIG. 1B, a solid gap filler 206 may be positioned between the circuit board 202 and laser module chassis 201 in order to provide a heat transfer path from the circuit board to the laser module chassis in order to dissipate heat generated by the laser. The laser module chassis 201 may be formed of a rigid material with a high thermal conductivity, for example aluminum.

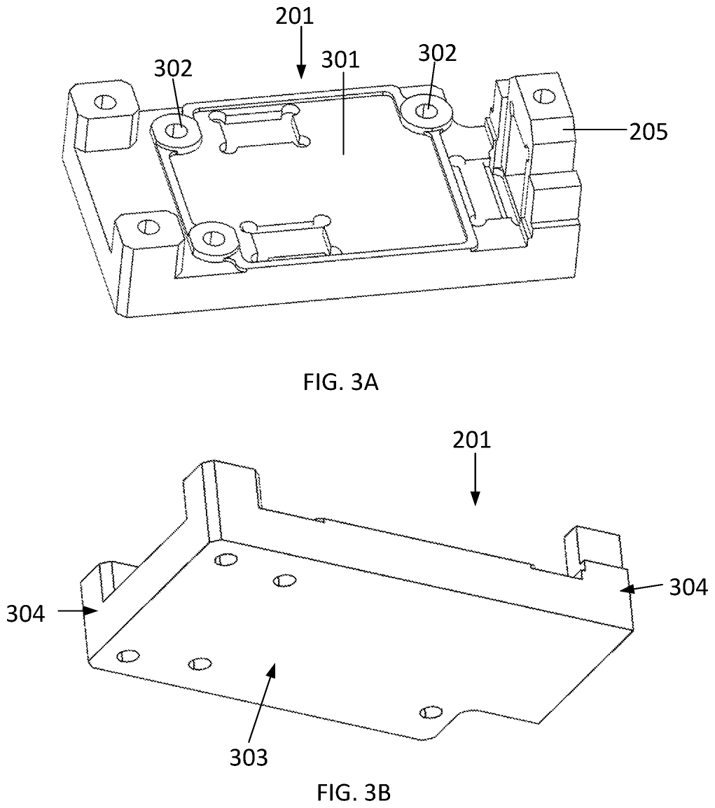

FIGS. 3A and 3B show views of a laser module chassis 201. The laser module 200 comprises a laser module chassis 201. FIG. 3A shows a top side including a recess 301 for receiving the solid gap filler 206, and holes 302 for receiving fasteners 203. FIG. 3B shows a bottom side including a bottom surface 303. When coupled to the chassis 101, the bottom surface 303 faces the mounting surface 102 and is supported by the gap filler between the laser module 200 and the chassis 101. The laser module chassis 201 further comprises side surfaces 304 which are adhered to alignment blocks 500, as shown for example in FIGS. 7G and 7H.

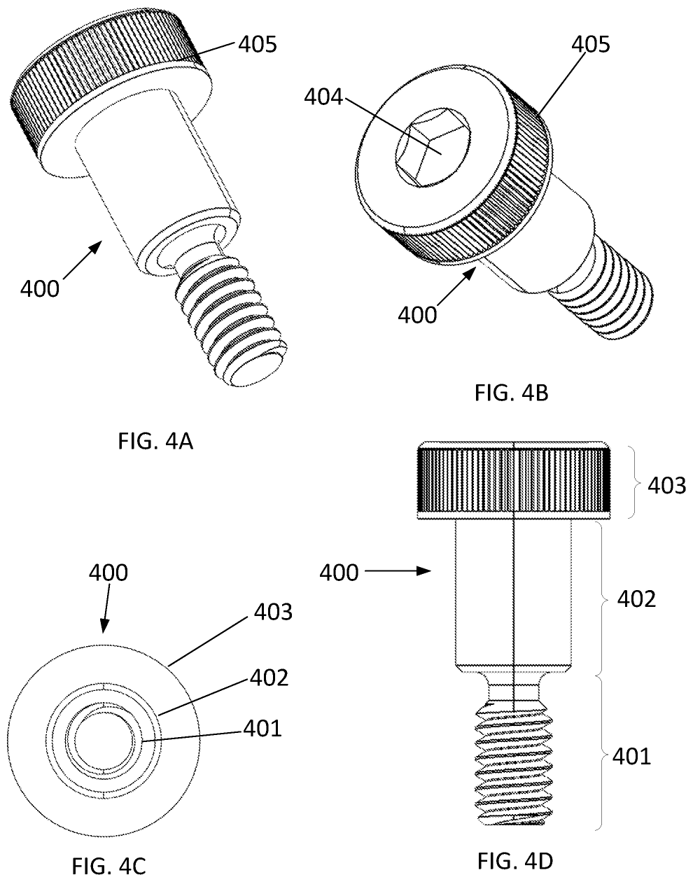

FIGS. 4A-4D show views of a shoulder screw 400. The shoulder screw 400 comprises a threaded end 401, a central unthreaded portion 402, and a head 403. The threaded end 401 threadedly couples to holes 103 of the chassis 101 in order to fixedly couple the shoulder screw 400 to the chassis 101. The central unthreaded portion 402 defines a circular cross-section with a diameter corresponding to a width of an elongated slot of an alignment block. The head 403 comprises a drive 404 on an end for receiving a tool to rotate the shoulder screw to threadedly couple to the chassis 101. The side surface 405 of the head may be textured, for example with angled facets forming ridges. A textured side surface 405 improves the bond strength of an adhesive applied to the side surface. As shown in FIG. 4C, the threaded end 401 may have a diameter smaller than the central unthreaded portion 402, and the central portion 402 has a diameter smaller than the head 403.

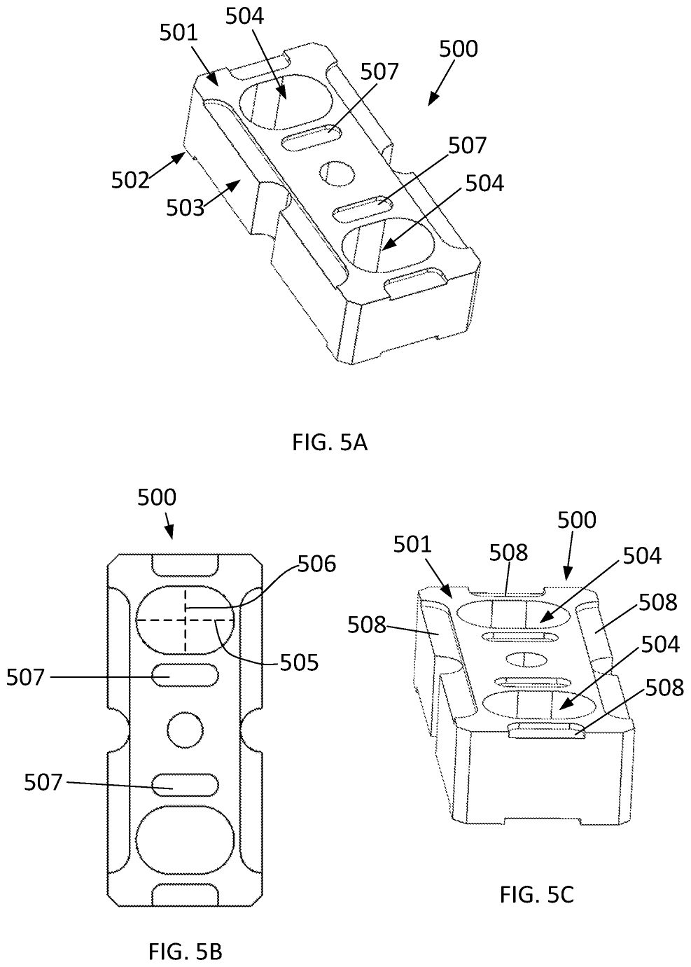

FIGS. 5A-5C show views of an alignment block 500. The alignment block may be a rectangular prism in shape, comprising a top surface 501, a bottom surface 502, and a front surface 503. In embodiments, the alignment block is symmetric and the top surface 501 includes identical features as the bottom surface 502. The alignment block 500 may comprise one or more elongated slots 504, for example two elongated slots 504 as shown in FIGS. 5A-5C, extending between the top surface 501 and the bottom surface 502. The elongated slots 504 are sized and shaped to receive the shoulder screws 400, as shown for example in FIG. 1A. A cross-section of the elongated slots 504 may have straight sides and rounded ends. The cross-section may have a length 505 between the round ends that is longer than a width 506 between the straight sides, as shown for example in FIG. 5B. The depth of the alignment block between the top surface 501 and the bottom surface 502 may be the same or substantially the same as the length of the central unthreaded portion 402 of the shoulder screw 400, and the width 506 may be the same or substantially the same as the diameter of the central unthreaded portion 402, so that with a shoulder screw 400 secured to the chassis 101 through the elongated slot 504 the alignment block 500 is able to be translated in a direction of the length 505, as shown for example in FIGS. 6A and 6B. Further, the width 506 is less than the diameter of the head 403 of the shoulder screw 400 so that the head 403 prevents movement of the alignment block 500 in a direction of the longitudinal axis of the shoulder screw.

In embodiments, the alignment block 500 may include features for receiving adhesive in order to increase the bond strength of an adhesive bonded to the alignment block 500. In embodiments, for example as shown in FIGS. 5A, an alignment block 500 comprises one or more recesses 507 on the top surface 501. The recesses 507 may receive adhesive bonded to a head 403 of a shoulder screw 400, for example as shown in FIG. 7F, in order to increase the bond strength between the shoulder screw and the alignment block. In embodiments, for example as shown in FIGS. 5A, an alignment block 500 comprises one or more recessed surfaces 508 around a perimeter of the top surface 501 and offset from the top surface 501, for example as shown in FIG. 5C. The recessed surface 508 may receive adhesive also bonded to the laser module chassis 201, for example as shown in FIGS. 7G and 7F, in order to increase the bond strength between the laser module chassis 201 and the alignment block 500.

FIGS. 6A and 6B shows translation in a single degree of freedom of an alignment block 500 relative to shoulder screws 400 extending through the elongated slots 504 of the alignment block. Using two shoulder screws 400 extending through the elongated slots 504 prevents rotation of the alignment block around one of the shoulder screws. The alignment blocks are able to be positioned at any position between the example end positions shown in FIGS. 6A and 6B, in order to optimize the position of the alignment block 500 relative to the laser module 200 in order to fixedly couple the laser module 200 to the chassis 101 in an optically aligned orientation.

FIGS. 7A-7H show steps of an embodiment of fixedly coupling and optically aligning a laser module 200 relative to a chassis 101 of a transmission module 100 of a LiDAR assembly. As shown in FIG. 7A, the chassis 101 may be pre-assembled with an optical lens assembly 104 prior to coupling of the laser module 200. In embodiments, one or more alignment blocks 500 may be placed on the mounting surface 102 of the chassis 101 around a location where the laser module 200 will be positioned. In the embodiment shown in FIG. 7B, two alignment blocks 500 are positioned perpendicularly to each other and oriented with the elongated slots 504 over the holes 103 in the chassis 101. As noted, other numbers of alignment blocks may be used, for example 1, 2, 3 or 4.

As shown in FIG. 7C, two shoulder screws 400 may be used to movably couple each alignment block 500 to the chassis 101 in order to allow the alignment blocks to be translated in one direction relative to the chassis 101, for example as shown in FIGS. 6A and 6B. With two alignment blocks oriented perpendicularly, as shown for example in FIG. 7C, the directions of translation of the two alignment blocks are orthogonal, which is beneficial in providing independent adjustment of the adhesive coupling points between the alignment blocks and the laser module.

With the alignment blocks 500 movably coupled to the chassis 101, a laser module 200 may be positioned adjacent the alignment blocks 500, as shown for example in FIG. 7D. Prior to, or simultaneously with, placing the laser module 200, a gap filler 701 may be applied as a non- solid gap filler to the mounting surface 102 in an area under the placement of the laser module 200. When applied as a non-solid gap filler, the gap filler 701 may have a low viscosity and be highly conformable. Examples of non-solid gap filler include Sarcon SPG-50A. To allow for movement of the alignment blocks 500, the non-solid gap filler may not be applied between the bottom surface 502 of the alignment blocks 500 and the mounting surface 102. Further, the non-solid gap filler may be prevented from being applied to surfaces where adhesive is to be applied in order to prevent curing issues caused by contacting non-solid gap filler with adhesive. The gap filler 701 may support the laser module prior to and after curing of the non-solid gap filler. The gap filler 701 provides a thermal path between the laser module 200 and the chassis 101 in order to dissipate heat generated by the laser.

To optically align the laser module 200 relative to the optical lens assembly 104, the laser module 200 may be manipulated about one or more of the six degrees of freedom, i.e. xyz translation and xyz rotation, and an output beam from the optical lens assembly 104 may be observed to determine that the laser module 200 is in an optically aligned orientation. In embodiments, an alignment jig may be used to orient the optical lens assembly to a position and maintain the optical lens assembly in the aligned position. Manipulation of the laser module may cause a redistribution of the uncured non-solid gap filler between the laser module chassis 201 and the mounting surface 102 of the chassis 101 so that no air gaps are present after curing in order to maintain the thermal path.

Prior to, or during, the manipulation of the laser module 200 for optical alignment, the alignment blocks 500 may be translated to a position to be directly adjacent to the laser module 200 in the optically aligned orientation. As shown for example in FIGS. 7E and 7F, one or more portions of adhesive 702 may be applied between the heads 403 of the shoulder screws 400 and the alignment block 500. The portions of adhesive 702 may be applied to the textured side surface 405 of the head 403 and/or to the recesses 507 or recessed surfaces 508 of the alignment block 500 in order to improve the bond strength between the shoulder screw 400 and the alignment block 500. When the adhesive 702 is cured, the cured adhesive 702 fixedly couples the alignment block 500 to the shoulder screws 400, so that alignment blocks cannot move relative to the shoulder screws, and therefore with the shoulder screws 400 fixedly coupled to the chassis 101 the alignment block 500 is fixedly coupled to the chassis 101. The application of adhesive 702 may be performed prior to, or during, the manipulation of the laser module 200 for optical alignment. The curing of adhesive 702 may be performed prior to, during, and or after the manipulation of the laser module 200 for optical alignment.

As shown for example in FIGS. 7G and 7H, one or more portions of adhesive 703 may be applied between the alignment block 500 and the laser module 300. For example, as shown in FIG. 7H, the adhesive 703 may be applied to contact the recessed surface 508, the front surface 503 and/or the side surface 304 in order to improve the bond strength between the alignment block 500 and the laser module chassis 201. When cured, the portions of adhesive 703 fixedly couple the laser module 200 to the alignment block 500, and therefore with the alignment block 500 fixedly coupled to the chassis 101 through adhesive 702 the laser module 200 may be fixedly coupled to the chassis 101 in the optically aligned orientation. The application of adhesive 703 may be performed prior to, or during, the manipulation of the laser module 200 for optical alignment. The curing of adhesive 703 is performed with the laser module 200 in the optically aligned orientation. The curing of adhesive 703 may be performed after the curing of adhesive 702.

Examples of adhesives 702 and 703 to be applied between the shoulder screws 400 and the alignment blocks 500, and between the alignment blocks 500 and the laser module chassis 201 include for example Henkel Loctite Eccobond UV glue or similar adhesives. The curing process for the adhesives may be one or more of UV curing, and thermal curing.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, any of the examples, alternative examples, etc., and the concepts thereof may be applied to any other examples described and/or within the spirit and scope of the disclosure.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

What is claimed is:

1. A method of optically aligning a laser module with an optical lens assembly in a LiDAR system, wherein the optical lens assembly is coupled to a chassis, the method comprising:
movably coupling a first alignment block to the chassis with a first screw fixedly coupled to the chassis:
applying a first portion of adhesive on the first alignment block and the first screw;
applying a second portion of adhesive on the first alignment block and the laser module;
applying a non-solid gap filler between the laser module and the chassis;
orienting the laser module relative to the optical lens assembly, with the non-solid gap filler between the chassis and the laser module, to an optically aligned orientation wherein a path of a laser beam emitted from the laser module is oriented with an optical path in the optical lens assembly;
curing the non-solid gap filler between the chassis and the laser module;
curing the first portion of adhesive in order to fixedly couple the first alignment block to the first screw and the chassis; and
curing the second portion of adhesive, after curing the first portion of adhesive, with the laser module in the optically aligned orientation, in order to fixedly couple the laser module to the first alignment block and the chassis in the optically aligned orientation.

2. The method of claim 1, wherein the first alignment block is movably coupled to the chassis so that the first alignment block is translatable relative to the chassis, and
wherein the method further comprises translating relative to the chassis after coupling the first alignment block to the chassis and prior to curing the first portion of adhesive.

3. The method of claim 1, wherein the first alignment block comprises a rectangular prism body defining a first elongated slot and a second elongated slot,
wherein movably coupling the first alignment block to the chassis with the first screw comprises positioning the first screw within the first elongated slot;
wherein the method further comprises:
securing the first alignment block to the chassis with a second screw positioned within the second elongated slot, wherein the first and second elongated slots and the first and second screws are configured to allow the first alignment block to translate in a single degree of freedom relative to the chassis; and
translating the first alignment block relative to the first and second screws after coupling the first alignment block to the chassis and prior to curing the first portion of adhesive.

4. The method of claim 3, wherein the first and second screws are shoulder screws each comprising a threaded end, an unthreaded central portion, and a head,
wherein the first and second elongated slots each define a depth, a length and a width less than the length,
wherein the unthreaded central portions of each of the first and the second screws define a first diameter corresponding to the width of the first and second elongated slots, and
wherein the heads of each of the first and second screws define a second diameter greater than the first diameter and greater than the widths of the first and second elongated slots.

5. The method of claim 4, wherein the heads of each of the first and second screws comprise a textured side wall surface, and
wherein applying the first portion of adhesive on the first alignment block and the first screw comprises applying the first portion on the textured side wall surface of the first screw.

6. The method of claim 5, wherein the first alignment block defines a recess between the first elongated slot and the second elongated slot, and
wherein applying the first portion of adhesive on the first alignment block and the first screw comprises applying the first portion in the recess.

7. The method of claim 6, wherein the first alignment block defines a top surface and a recessed surface offset from the top surface,
wherein the heads of the first and second screws project away from the top surface of the secured first alignment block; and
wherein applying the second portion of adhesive on the first alignment block and the laser module comprises applying the second portion of adhesive onto the recessed surface.

8. The method of claim 1, wherein the laser module comprises:
a second chassis;
a circuit board fixedly coupled to the second chassis; and
a laser fixedly coupled to the circuit board;
wherein applying the non-solid gap filler between the laser module and the chassis comprises applying the non-solid gap filler between the second chassis and the chassis.

9. The method of claim 1, wherein the non-solid gap filler is not applied between the first alignment block and the chassis.

10. The method of claim 1, wherein the first portion of adhesive and the second portion of adhesive do not contact the non-solid gap filler.

11. The method of claim 1, wherein curing the non-solid gap filler is performed simultaneously with or after orienting the laser module to the optically aligned orientation.

12. The method of claim 1, wherein curing the first portion of adhesive is performed prior to orienting the laser module to the optically aligned orientation.

13. The method of claim 1, further comprising:
securing a second alignment block to the chassis with a third screw fixedly coupled to the chassis;
applying a third portion of adhesive on the second alignment block and the third screw;
applying a fourth portion of adhesive on the second alignment block and the laser module, wherein the first alignment block is positioned on a first side of the laser module and the second alignment block is positioned on a second side of the laser module perpendicular to the first side of the laser module;
curing the third portion of adhesive in order to fixedly couple the second alignment block to the third screw and the chassis; and
curing the fourth portion of adhesive, after curing the third portion of adhesive, with the laser module in the optically aligned orientation, in order to fixedly couple the laser module to the second alignment block and the chassis in the optically aligned orientation.

14. A transmission module in a LiDAR system, comprising:
a chassis;
an optical lens assembly coupled to a chassis;
a first alignment block;
a first screw fixedly coupled to the chassis and extending through a first elongated slot of the first alignment block, wherein the first screw is fixedly coupled to the first alignment block with a first portion of adhesive; and
a laser module, wherein a second portion of adhesive is positioned between the laser module and the first alignment block so that the laser module is fixedly coupled to the first alignment block;
wherein the first and second portions of adhesive maintain the laser module in an optically aligned orientation with the optical lens assembly wherein a path of a laser beam emitted from the laser module is oriented with an optical path in the optical lens assembly.

15. The transmission module of claim 14, wherein the first screw and the first elongated slot are configured to allow the first alignment block to translate relative to the chassis prior to an application of the first portion of adhesive.

16. The transmission module of claim 14, further comprising:
a second screw fixedly coupled to the chassis and extending through a second elongated slot of the first alignment block, wherein the second screw is fixedly coupled to the first alignment block with a third portion of adhesive,
wherein the first alignment block comprises a rectangular prism body defining the first elongated slot and the second elongated slot.

17. The transmission module of claim 16, wherein the first and second screws are shoulder screws each comprising a threaded end, an unthreaded central portion, and a head,
wherein the first and second elongated slots each define a depth, a length and a width less than the length,
wherein the unthreaded central portions of each of the first and the second screws define a first diameter corresponding to the width of the first and second elongated slots, and
wherein the heads of each of the first and second screws define a second diameter greater than the first diameter and greater than the widths of the first and second elongated slots.

18. The transmission module of claim 17, wherein the heads of each of the first and second screws comprise a textured side wall surface, and
wherein the first portion of adhesive is bonded to the first alignment block and the textured side wall surface of the first screw.

19. The transmission module of claim 14, wherein the first alignment block comprises a top surface defining a recess, and
wherein the first portion of adhesive is bonded to the first alignment block within the recess and bonded to the first screw.

20. The transmission module of claim 14, wherein the first alignment block defines a top surface and a recessed surface offset from the top surface, and
wherein the second portion of adhesive is bonded to the recessed surface and a second chassis of the laser module.
